(19) United States
(12) Patent Application Publication
(10) Pub. No.: US 2023/0249514 A1
(43) Pub. Date: Aug. 10, 2023

(54) Solar Powered Vehicle Temperature Control Assembly

(71) Applicant: Leonard Mbagwu, Sugar Land, TX (US)

(72) Inventor: Leonard Mbagwu, Sugar Land, TX (US)

(21) Appl. No.: 17/666,704

(22) Filed: Feb. 8, 2022

(51) Int. Cl. B60H 1/00; B60L 8/00; B60R 16/03

(52) U.S. Cl. CPC B60H 1/00742; B60L 8/003; B60R 16/03; B60H 1/00964; B60H 1/00878

(57) ABSTRACT

A solar powered vehicle temperature control assembly for solar powered vehicle temperature control includes a solar panel positioned on the top surface of a roof a vehicle. The solar panel provides power to the solar powered vehicular temperature assembly. A plurality of weight cells positioned in the vehicle seat send readings to a control module. A thermal sensor reads the internal temperature within the interior of a vehicle and sends readings to the control module. The control module determines if the temperature reading falls within a set range of temperature. The control module is in electric communication with the vehicle air conditioning unit and heating system and can turn either on depending on the temperature reading. If the temperature reading is above the set range, the control module turns on the air conditioning unit. If the temperature reading is below the set range, the control module turns on the heating system.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle temperature control systems and more particularly pertains to a new vehicle temperature control system powered by a solar panel and having a plurality of weight cells.

### (2) Description of Related Art Including Information Disclosed Under 37 CFR 1.97 and 1.98

The prior art relates to vehicle temperature control systems. The prior art relates to a variety of temperature control systems that monitor the temperature within a vehicle's interior and adjusts the temperature to a set range. Known prior art lacks a vehicle temperature control system comprising a solar panel for a power source and a plurality of weight cells positioned within the vehicle seats.

### BRIEF SUMMARY OF THE INVENTION

An embodiment of the disclosure meets the needs presented above by generally comprising a solar panel positioned on the top surface of a vehicles roof. The solar panel provides power to the temperature control system within the vehicle. A plurality of weight cells obtains power from the solar panel. Each of the weight cells are positioned within a vehicle seat and record data of weight applied. A thermal sensor is positioned on the front surface of the vehicles dash. The thermal sensor records the temperature of the vehicles interior space. A control module is in electric communication with each of the weight cells and with the thermal sensor. The control module reads both the weight data and the temperature data and interprets if further action is needed to maintain the vehicle's interior temperature within a set range.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a manual in-use view of a solar powered vehicle temperature control assembly according to an embodiment of the disclosure.

FIG. 2 is an automatic in-use view of an embodiment of the disclosure.

FIG. 3 is a side view of an embodiment of the disclosure.

FIG. 4 is a block diagram view of an embodiment of the disclosure.

FIG. 5 is a detailed view of elements in electric communication of an embodiment of the disclosure.

### DETAILED DESCRIPTION OF THE INVENTION

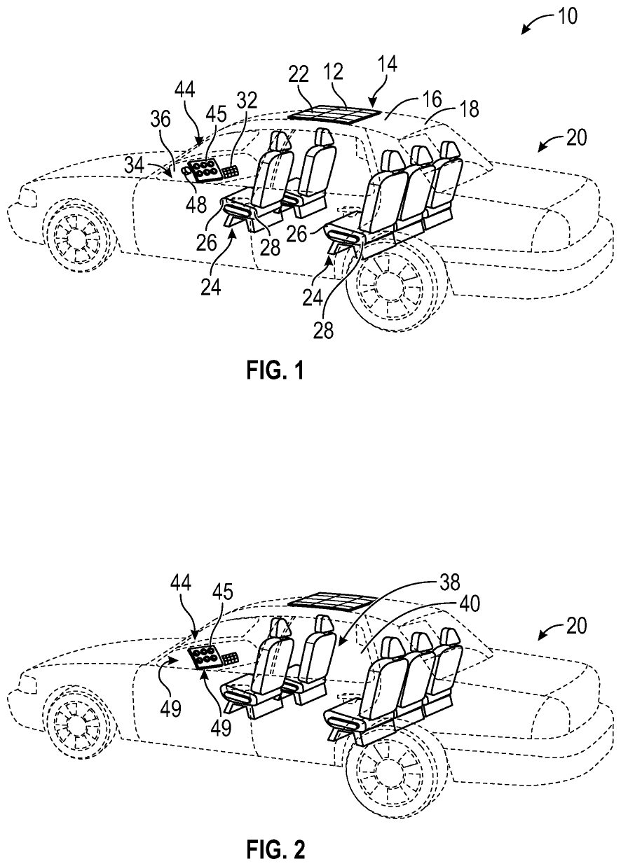

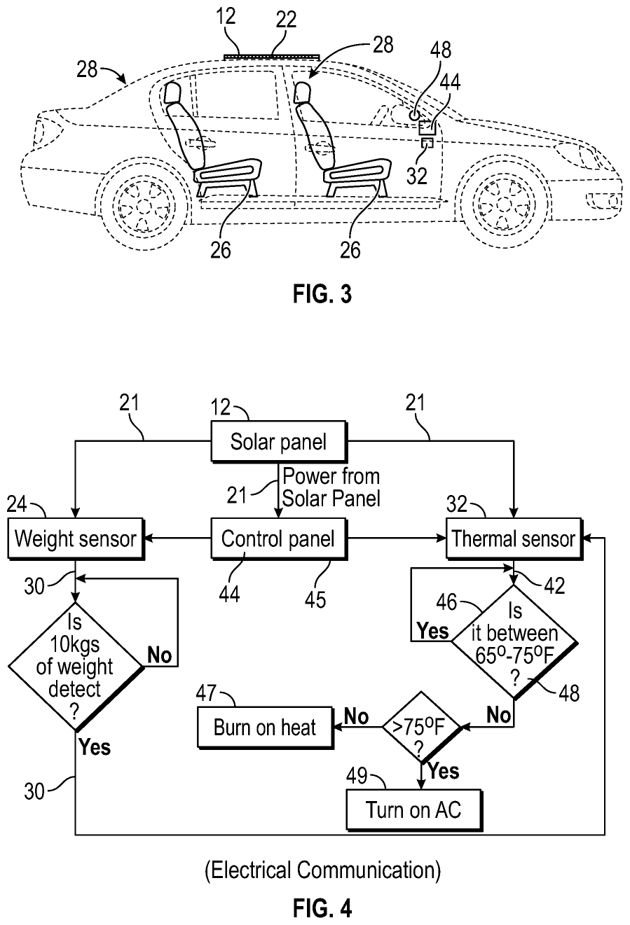

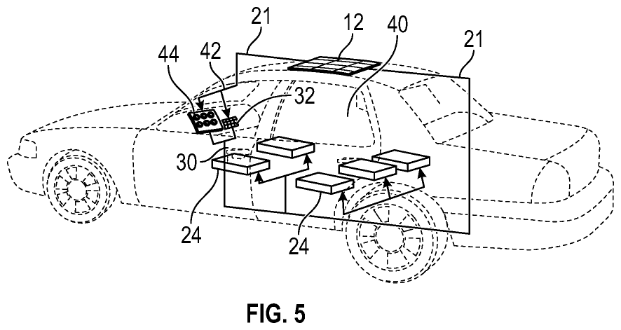

With reference now to the drawings, and in particular to FIGS. 1 through 5 thereof, a new vehicle temperature control system embodying the principles and concepts of an embodiment of the disclosure and generally designated by the reference numeral 10 will be described.

As best illustrated in FIGS. 1 through 5, the solar powered vehicle temperature control assembly 10 generally comprises a solar panel 12. The solar panel 12 has a rectangular shape 14 and is positioned on the top surface 16 of a roof 18 of a vehicle 20. The solar panel 12 is a semi conduction material 22. As sunlight is cast onto the solar panel, the solar panel 12 obtains heat from the sunlight and converts the heat into electric energy 21. The purpose of the solar panel 12 is being the power source for the solar powered vehicle temperature control assembly 10.

A plurality of weight cells 24 is in electric communication with the solar panel 12. Each of the weight cells 24 receives electric energy 21 from the solar panel 12. Each of the weight cells 24 is positioned within the seat cushion 26 of a vehicle seat 28. Each of the weight cells 24 are needed to record the weight applied to the seat cushion 26 as a weight reading 30. Each of the weight cells 24 sends the weight reading 30 to a control module 44.

A thermal sensor 32 is positioned on the front surface 34 of a vehicle dash panel 36. The purpose of the thermal sensor 32 is to record the internal temperature 38 within the interior space 40 of the vehicle 20. The thermal sensor 32 receives electric energy 21 from the solar panel 12. The thermal sensor 32 records the internal temperature 38 as a temperature reading 42. The thermal sensor 32 sends the temperature reading 42 to the control module 44.

The control module 44 is positioned on the front surface 34 of the vehicle dash panel 36. The control module 44 acts as a central processing unit 45 for the solar powered vehicle temperature control assembly 10. The control module 44 is in electric communication with each of the weight cells 24 and with the thermal sensor 32. Each of the weight cells 24 and the thermal sensor 32 sends the weight readings 30 and the temperature readings 42 to the control module 44. The purpose of the control module 44 is analyze the weight readings 30 and temperature readings 42 before interpreting if further action is needed to maintain the internal temperature 38 of the vehicle 20 within a set range of temperature 46.

A switch 48 is positioned on the front surface 34 of the vehicle dash panel 36. The switch 48 serves an actuator that can either turn on or off the control module 44. The switch 48 is in electric communication with the control module 44. The purpose of the switch 48 is for providing driver with the ability to turn the control module 44 on or off. The switch 48 is an optional element configured for making the control module 44 manually operated.

In use, the vehicle 20 is turned off and the driver leaves the vehicle 20. The solar panel 12 sends power 21 to the temperature control assembly 10. The plurality of weight cells 24 sends weight readings 30 to the control module 44. If below ten pounds is detected, then the assembly 10 shuts off. If ten pounds or more is detected, then the thermal sensor 32 begins recording the internal temperature 38 within the interior space 40 of the vehicle 20.

Furthermore, the control module 44 reads the temperature reading 42 and determines if it is within the set range of temperature 46. If the temperature reading 42 is above the set range of temperature 46, then the control module 44 turns on the vehicle air conditioning 49 unit to cool down the vehicle 20. If the temperature reading 42 is under the set range of temperature 46, then the control module 44 turns on the heating system 47 in the vehicle 20.

Once the internal temperature 38 falls within the set range of temperature 46, the control module 44 shuts off either the vehicle air conditioning unit 49 or the heating system 47. The thermal sensor 32 continues to record the internal temperature 38. This process continues until the vehicle 20 turns on again.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. a solar powered vehicle temperature control assembly comprising:
a solar panel, said solar panel being a power source, said solar panel being configured for absorbing the heat from sunlight into said semi conductive material and converting the heat to electric energy;
a plurality of weight cells, said solar panel supplies power to each of said weigh cells, each of said weigh cell being configured for measuring a range of weight and recording the data of the weight;
a thermal sensor, said thermal sensor being configured for recording temperature readings of the vehicle's interior;
a control module, said control module configured for interpreting temperature readings from said thermal sensor and for interpreting data from each of said weight cells.

2. The solar powered vehicle temperature control assembly of claim 1, further comprising said solar panel having a semi conductive material.

3. The solar powered vehicle temperature control assembly of claim 1, further comprising said solar panel being positioned on a top surface of a vehicle.

4. The solar powered vehicle temperature control assembly of claim 1, further comprising each of the weight cells is positioned within a vehicular seat.

5. The solar powered vehicle temperature control assembly of claim 1, further comprising each of said weight cells is in electric communication with said solar panel, said solar panel supplies power to each of said weigh cells.

6. The solar powered vehicle temperature control assembly of claim 1, further comprising said thermal sensor being a temperature sensor.

7. The solar powered vehicle temperature control assembly of claim 1, further comprising said thermal sensor being in electric communication with said solar panel and with said plurality of weight cells.

8. The solar powered vehicle temperature control assembly of claim 1, further comprising said thermal sensor being positioned on a front surface of the dash of the vehicle.

9. The solar powered vehicle temperature control assembly of claim 1, further comprising said control module being a central processing unit.

10. The solar powered vehicle temperature control assembly of claim 1, further comprising said control module being positioned on said front surface of the dash of the vehicle.

11. The solar powered vehicle temperature control assembly of claim 1, further comprising said control module being in electric communication with said solar panel and with said plurality of weight cells and with said thermal sensor.

12. The solar powered vehicle temperature control assembly of claim 1, further comprising a switch, said switch can be positioned on said front surface of the dash of the vehicle, said switch can be positioned adjacent to said control module, said switch being an actuator, said switch can start or stop said control module from reading data.

13. A solar powered vehicle temperature control assembly comprising:
a solar panel, said solar panel having a semi conductive material, said solar panel being positioned on a top surface of a vehicle, said solar panel being a power source, said solar panel being configured for absorbing the heat from sunlight into said semi conductive material and converting the heat to electric energy;
a plurality of weight cells, each of the weight cells is positioned within a vehicular seat, each of said weight cells is in electric communication with said solar panel, said solar panel supplies power to each of said weigh cells, each of said weigh cell being configured for measuring a range of weight and recording the data of the weight;
a thermal sensor, said thermal sensor being a temperature sensor, said thermal sensor being in electric communication with said solar panel and with said plurality of weight cells, said thermal sensor being positioned on a front surface of the dash of the vehicle, said thermal sensor being configured for recording temperature readings of the vehicle's interior;
a control module, said control module being a central processing unit, said control module being positioned on said front surface of the dash of the vehicle, said control module being in electric communication with said solar panel and with said plurality of weight cells and with said thermal sensor, said control module configured for interpreting temperature readings from said thermal sensor and for interpreting data from each of said weight cells; and
a switch, said switch can be positioned on said front surface of the dash of the vehicle, said switch can be positioned adjacent to said control module, said switch being an actuator, said switch can start or stop said control module from reading data.
